(19) United States
(12) Patent Application Publication
(10) Pub. No.: US 2011/0109742 A1
(43) Pub. Date: May 12, 2011

(54) BROKER MEDIATED VIDEO ANALYTICS METHOD AND SYSTEM

(76) Inventors: Robert Laganiere, Gatineau (CA); William Murphy, Glace Bay (CA); Pascal Blais, Ottawa (CA); Jason Phillips, Lower Sackville (CA)

(21) Appl. No.: 12/900,374

(22) Filed: Oct. 7, 2010

Related U.S. Application Data
(60) Provisional application No. 61/249,398, filed on Oct. 7, 2009.

(51) Int. Cl. H04N 5/225; H04N 7/18

(52) U.S. Cl. 348/143; 348/E05.024; 348/E07.085

(57) ABSTRACT

A method comprises transmitting video data from a source end to a central server via a Wide Area Network (WAN). The video data includes video data relating to an event of interest, and is captured using a video camera disposed at the source end. Via a plurality of streams, the video data is transmitted from the central server to each one of a plurality of different video analytics engines. Different video analytics processing of the video data is performed using each one of the plurality of different video analytics engines.

### FIELD OF THE INVENTION

The instant invention relates generally to video analytics, and more particularly to a broker mediated method and system for performing video analytics.

### BACKGROUND OF THE INVENTION

Modern security and surveillance systems have come to rely very heavily on the use of video surveillance cameras for the monitoring of remote locations, entry/exit points of buildings or other restricted areas, and high-value assets, etc. The majority of surveillance video cameras that are in use today are analog. Analog video surveillance systems run coaxial cable from closed circuit television (CCTV) cameras to centrally located videotape recorders or hard drives. Increasingly, the resultant video footage is compressed on a digital video recorder (DVR) to save storage space. The use of digital video systems (DVS) is also increasing; in DVS, the analog video is digitized, compressed and packetized in IP, and then streamed to a server.

More recently, IP-networked digital video systems have been implemented. In this type of system the surveillance video is encoded directly on a digital camera, in H.264 or another suitable standard for video compression, and is sent over Ethernet at a lower bit rate. This transition from analog to digital video is bringing about long-awaited benefits to security and surveillance systems, largely because digital compression allows more video data to be transmitted and stored. Of course, a predictable result of capturing larger amounts of video data is that more personnel are required to review the video that is provided from the video surveillance cameras. Advantageously, storing the video can reduce the amount of video data that is to be reviewed, since the motion vectors and detectors that are used in compression can be used to eliminate those frames with no significant activity. However, since motion vectors and detectors offer no information as to what is occurring, someone still must physically screen the captured video to determine suspicious activity.

The market is currently seeing a migration toward IP-based hardware edge devices with built-in video analytics, such as IP cameras and encoders. Video analytics electronically recognizes the significant features within a series of frames and allows the system to issue alerts or take other actions when specific types of events occur, thereby speeding real-time security response, etc. Automatically searching the captured video for specific content also relieves personnel from tedious hours of reviewing the video, and decreases the number of personnel that is required to screen the video. Furthermore, when ‘smart’ cameras and encoders process images at the edge, they record or transmit only important events, for example only when someone enters a predefined area that is under surveillance, such as a perimeter along a fence. Accordingly, deploying an edge device is one method to reduce the strain on a network in terms of system requirements and bandwidth.

Unfortunately, deploying ‘smart’ cameras and encoders at the edge carries a significantly higher cost premium compared to deploying a similar number of basic digital or analog cameras. Furthermore, since the analytics within the cameras is designed into the cameras there is a tradeoff between flexibility and cost, with higher cost solutions providing more flexibility. In essence, to support changing functionality requires a new camera or a significantly higher cost camera initially.

Greater flexibility and lower cost may also be achieved when video data is streamed locally to a centralized resource for video analytics processing. International patent publication number WO 2008/092255, which was published on 7 Aug. 2008, discloses a task-based video analytics processing approach in which video data is streamed from IP cameras or video recorders at the edge to co-located shared video analytics resources via a Local Area Network. In particular, a video analytics task manager routes video analytics tasks to a shared video analytics resource in response to a video analytics task request. The shared video analytics resource obtains video data to be analyzed in response to receipt of the video analytics task, and performs requested video analytics on the obtained video data. Since the video data is transmitted via a LAN, which is limited to a relatively small geographic area, it is a relatively simple matter to provide a network between the edge devices and the centralized processing facilities that has sufficient bandwidth to accommodate large amounts of video data. Unfortunately, such a system cannot be expanded easily to include very many additional edge devices since the processing capabilities of the system within the LAN are finite. Similarly, the ability to perform multiple video analytics functions in parallel is limited by the processing capabilities of the system. Simply adding more servers to process the video data from additional edge devices, or to process video data using a plurality of different video analytics engines, is very expensive in terms of capital investment and in terms of the additional ongoing maintenance, support and upgrading that is required.

Accordingly, it would be advantageous to provide a method and system that overcomes at least some of the above-mentioned limitations.

### SUMMARY OF EMBODIMENTS OF THE INVENTION

In accordance with an aspect of the invention there is provided a method comprising: transmitting video data from a source end to a central server via a Wide Area Network (WAN), the video data including video data relating to an event of interest captured using a video camera disposed at the source end; via a plurality of streams, transmitting the video data from the central server to each one of a plurality of different video analytics engines; and, performing different video analytics processing of the video data using each one of the plurality of different video analytics engines.

In an embodiment the WAN is the Internet.

In an embodiment the plurality of different video analytics engines is a subset less than the whole of a larger group of available video analytics engines.

In an embodiment the video data is pre-processed at the source end, and the central server selects the plurality of different video analytics engines from the larger group of available video analytics engines based on a result of the pre-processing.

In an embodiment the central server selects the plurality of different video analytics engines from the larger group of available video analytics engines based on a video analytics engine subscription-profile associated with the source end.

In an embodiment the central server selects the plurality of different video analytics engines from the larger group of available video analytics engines based on a preference-profile associated with the source end.

In an embodiment comprising first video analytics processing of the video data is performed using a first video analytics engine that is in execution on a processor of the central server, and the central server selects the plurality of different video analytics engines from the larger group of available video analytics engines based on a result of the first video analytics.

In an embodiment, based on at least a result provided by one of the plurality of different video analytics engines, a signal is generated for performing a predetermined action in response to an occurrence of the event of interest at the source end, and the signal relates to billing information.

In accordance with an aspect of the invention there is provided a method comprising: capturing video data using a first type of sensor comprising a video camera disposed at a source end and capturing other data using a second type of sensor disposed at the source end, the first type of sensor different than the second type of sensor, the video data and the other data each including data relating to an occurrence of a same event of interest at the source end; transmitting the video data and the other data from the source end to a central server via a Wide Area Network (WAN); transmitting the video data from the central server to a video analytics engine via a first IP stream and transmitting the other data to a data analytics engine via a second IP stream, the data analytics engine selected from a plurality of available data analytics engines in dependence upon a type of the other data; and, performing video analytics processing of the video data using the video analytics engine and performing data analytics processing of the other data using the selected data analytics engine.

In an embodiment, based on determining a correlation between a result provided by the video analytics engine and a result provided by the selected data analytics engine, a signal is generated for performing a predetermined action in response to an occurrence of the event of interest at the source end.

In an embodiment the signal is for providing an alert that is indicative of an occurrence of the event of interest at the source end.

In an embodiment the alert is provided to an indicated user, wherein the alert comprises at least a portion of the video data relating to the event of interest for being displayed to the indicated user.

In an embodiment the alert is a human intelligible alert for being provided to the indicated user.

In an embodiment the alert is provided via a wireless communications channel to a portable electronic device associated with the indicated user.

In an embodiment the signal is for forwarding at least the video data for review by a human operator.

In an embodiment the signal is for storing at least a portion of at least the video data.

In an embodiment the signal is for providing at least a portion of the video data to another video analytics engine for further video analytics processing.

In an embodiment the WAN is the Internet.

In an embodiment the signal relates to billing information.

In an embodiment the second type of sensor is selected from the group consisting of an audio sensor, a microphone, a heat sensor, a motion sensor, a passive infrared sensor, a pressure sensor, a smoke sensor, and another airborne particle sensor.

In an embodiment the correlation is a correlation with respect to time.

In an embodiment the correlation is a correlation with respect to space.

In accordance with an aspect of the invention there is provided a method comprising: capturing video data using a video camera disposed at a source end, the video data including video data relating to an event of interest captured using the video camera; transmitting the video data to a video analytics broker; transmitting the video data from the video analytics broker to at least one video analytics engine of a plurality of different video analytics engines that are accessible by the video analytics broker; and, performing video analytics on the video data using the at least one video analytics engine.

In an embodiment the alert is provided via a wireless communications channel to a portable electronic device associated with the indicated user.

In an embodiment the alert is provided in dependence upon determining a correlation between a result provided by a first one of the plurality of different video analytics engines and a result provided by a second one of the plurality of different video analytics engines.

In an embodiment the signal is for forwarding the video data for review by a human operator.

In an embodiment the signal is for storing at least a portion of the video data.

In an embodiment the signal is for providing at least a portion of the video data to another video analytics engine for further video analytics processing.

In an embodiment the video analytics broker is in communication with the source end a Wide Area Network (WAN).

In an embodiment the video data is pre-processed at the source end, and the video analytics broker selects the at least one video analytics engine based on a result of the pre-processing.

In an embodiment the video analytics broker selects the at least one video analytics engine based on a video analytics engine subscription-profile associated with the source end.

In an embodiment the video analytics broker selects the at least one video analytics engine based on a preference-profile associated with the source end.

In an embodiment the signal relates to billing information.

In an embodiment the video analytics broker is local to the source end.

In accordance with an aspect of the invention there is provided a method comprising: providing first video data from a video data source via a Wide Area Network (WAN) to a video analytics broker; at the video analytics broker determining, based upon at least one of a source of the first video data and a content of the first video data, a video analytics engine to which to provide video data for processing thereof, the video analytics engine other than a same processing system as the video analytics broker and in communication therewith via a communication network; and, routing the video data to the video analytics engine for processing thereof.

In an embodiment the first video data and the video data are the same data.

### BRIEF DESCRIPTION OF THE DRAWINGS

Exemplary embodiments of the invention will now be described in conjunction with the following drawings, wherein similar reference numerals denote similar elements throughout the several views, in which:

FIG. 1 is a schematic block diagram of a system that is suitable for implementing a method according to an embodiment of the instant invention;

FIG. 2 is a schematic block diagram of a system that is suitable for implementing a method according to an embodiment of the instant invention;

FIG. 3 is a schematic block diagram of a system that is suitable for implementing a method according to an embodiment of the instant invention;

FIG. 4 is a schematic block diagram of a system that is suitable for implementing a method according to an embodiment of the instant invention;

FIG. 5 is a simplified flow diagram of a method according to an embodiment of the instant invention;

FIG. 6 is a simplified flow diagram of a method according to an embodiment of the instant invention;

FIG. 7 is a schematic block diagram of a system that is suitable for implementing a method according to an embodiment of the instant invention;

FIG. 8 is a simplified flow diagram of a method according to an embodiment of the instant invention.

### DETAILED DESCRIPTION OF EMBODIMENTS OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed, but is to be accorded the widest scope consistent with the principles and features disclosed herein.

As discussed supra with reference to WO 2008/092255, the limited processing resources that are available within a LAN tends to render problematic the possibility of performing multiple different video analytics functions in parallel with the same video data. One solution is to buffer the video data and perform the multiple different video analytics functions in series. Unfortunately, this approach is not suitable in real time applications and it ties up the limited amount of processing resources, which may be shared by other video sources, thereby preventing of other video data from being processed.

An alternate approach contemplates moving the processing infrastructure away from the client's local network and “into the cloud.” Cloud computing is a general term for anything that involves delivering hosted services over the Internet. A cloud service has three distinct characteristics that differentiate it from traditional hosting: it is sold on demand, typically by the minute or the hour; it is elastic, a user can have as much or as little of a service as they want at any given time; and the service is fully managed by the provider, the client needs nothing but a personal computer and Internet access. Moving the video analytics processing into the cloud may reduce a client's initial capital expenditure, avoid the need for the client to maintain a local server farm, while at the same time providing available additional processing capability to support significant expansion of a client's video analytics monitoring system. Furthermore, cloud computing as applied to video analytics supports parallel processing with multiple different video analytics engines and/or hierarchal processing with different video analytics engines. In addition, some video analytics processing may be “farmed out” to third parties if specialized video analytics engines are required.

In many instances, modern IP network video cameras support high definition video formats that result in very large amounts of video data being captured. Even the amount of video data that is captured by VGA cameras can be significant in a monitoring system of moderate size. Unfortunately, the bandwidth that is available across a WAN such as the Internet is limited and cannot be increased easily. A major obstacle to the adoption of cloud computing for video analytics has been the inability to transmit the video data across the WAN to the centralized video analytics processing resources, due to the limited bandwidth of the WAN. In particular, providing multiple streams of the same video data to be processed by a plurality of different video analytics engines results in extremely high network traffic levels, which may overload the network. For example, a single stream provided to five video analytics engines results in five times the bandwidth being consumed from the source to the WAN. In the description that follows, methods and systems are described in which a single IP stream is established for transmitting video data between the source end and a broker system “in the cloud.” According to at least some of the described embodiments, the video data is provided from the broker system to each of a plurality of different video analytics engines. For instance, the broker system opens a plurality of IP streams and provides the video data to the plurality of different video analytics engines via the plurality of IP streams.

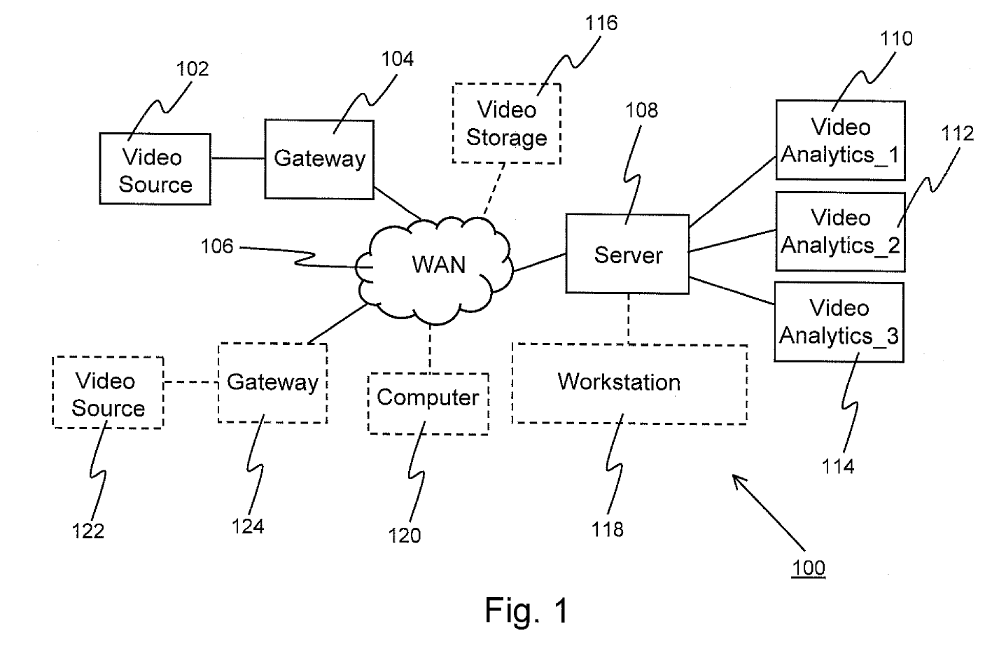

Referring to FIG. 1, shown is a schematic block diagram of a system that is suitable for implementing a method according to an embodiment of the instant invention. The system 100 includes a video source 102, which is disposed at a source end. By way of a specific and non-limiting example, the video source 102 is a network IP camera, such as for instance an AXIS 211M Network Camera or another similar device. In the instant example the video source 102 is deployed at the source end for monitoring a known field of view (FOV). For example, the video source 102 monitors one of a parking lot, an entry/exit point of a building, and a stack of shipping containers. The video source 102 captures video data of the FOV at a known frame rate, typically 30 FPS, and performs on-board compression of the captured video data using a suitable compression standard such as for instance MPEG-4 or H.264. The compressed video data are provided to a central server 108 via gateway 104 and Wide Area Network (WAN) 106, such as for instance the Internet. Optionally, the video source 102 connects to the WAN 106 without the gateway 104. Optionally, the video source 102 is one of a still camera, another type of video camera, or a video data storage device.

The central server 108 receives transmitted video data from the video source 102 via a single IP stream over the WAN 106. Thereafter, the central server 108 provides the received video data to at least one of a plurality of available video analytics engines 110-114, which are indicated in FIG. 1 as Video Analytics_1 110, Video Analytics_2 112 and Video Analytics_3 114. In the example that is illustrated in FIG. 1, the central server 108 provides the video data over a Local Area Network (LAN), such as by opening a separate IP stream for each one of the video analytics engines 110-114 to which the video data is to be provided. By way of a specific and non-limiting example, during use each one of the different video analytics engines 110-114 is in execution on a different processor. For instance, during use each one of the different video analytics engines 110-114 is in execution on a processor of a different server of a server farm that is local to the central server 108. Alternatively, the central server 108 provides the video data over a Wide Area Network (WAN). It will be appreciated that a connection to the WAN of the central server is optionally far more robust and optionally has far greater bandwidth than a typical Internet connection via an ISP.

Referring still to FIG. 1, each of the different video analytics engines 110-114 performs a different video analytics function. By way of a specific and non-limiting example, Video Analytics_1 110 detects a vehicle within a data frame, Video Analytics_2 112 detects the vehicle license plate within a data frame, and Video Analytics_3 114 reads the license plate characters. By way of another specific and non-limiting example, Video Analytics_1 110 determines a number of people within a data frame, Video Analytics_2 112 detects loitering behavior within a data frame, and Video Analytics_3 114 performs facial recognition. As will be apparent to one of skill in the art, different applications require different video analytics engines and/or a different number of video analytics engines. Further, the video analytics engines need not perform related functions. A same frame is analyzable with respect to a presence of birds, the weather, and a presence of people each separately performed by different video analytics engines. Optionally, some or all of the video analytics engines 110-114 are fee-per-use-based or subscription based.

Further optionally, the system 100 includes a video storage device 116. By way of a specific and non-limiting example, the video storage device 116 is one of a digital video recorder (DVR), a network video recorder (NVR), or a storage device in box with a searchable file structure. The system 100 further optionally includes a workstation 118, including a not illustrated processor portion, display device and input device, which is in communication with server 108 for supporting end-user control and video review functions. Alternatively, the server 108 and the workstation 118 are combined, comprising for instance a personal computer including a display and input device. Optionally, a computer 120 is provided in communication with the WAN 106 for supporting remote access of the video data that is provided by the video source 102. For instance, a user uses a web browser application that is in execution on computer 120 for monitoring portions of the video data that are provided by the video source 102. Optionally, the computer 120 is a personal computer located at the source end or virtually anywhere else in the world. Alternatively, the computer 120 is a mobile electronic device, such as for instance one of a cell phone, a smart phone, a PDA, or a laptop computer.

Of course, optionally more than one video source is provided in communication with the central server 108. For instance, a second video source 122 is in communication with central server 108 via gateway 124 and Wide Area Network (WAN) 106. Optionally, the second video source 122 is the same type as video source 102. Alternatively the second video source 122 is a different type than video source 102. Further optionally, additional video sources are provided in communication with server 108. When different types of video sources are used, optionally the broker determines an engine suitable for the video data received. Further optionally, the broker modifies the video data in accordance with an input data requirement of the video analytics engine. Alternatively, the broker provides the video data to a separate processor for at least one of identification of a suitable analytics engine and reformatting of the data for the video analytics engine.

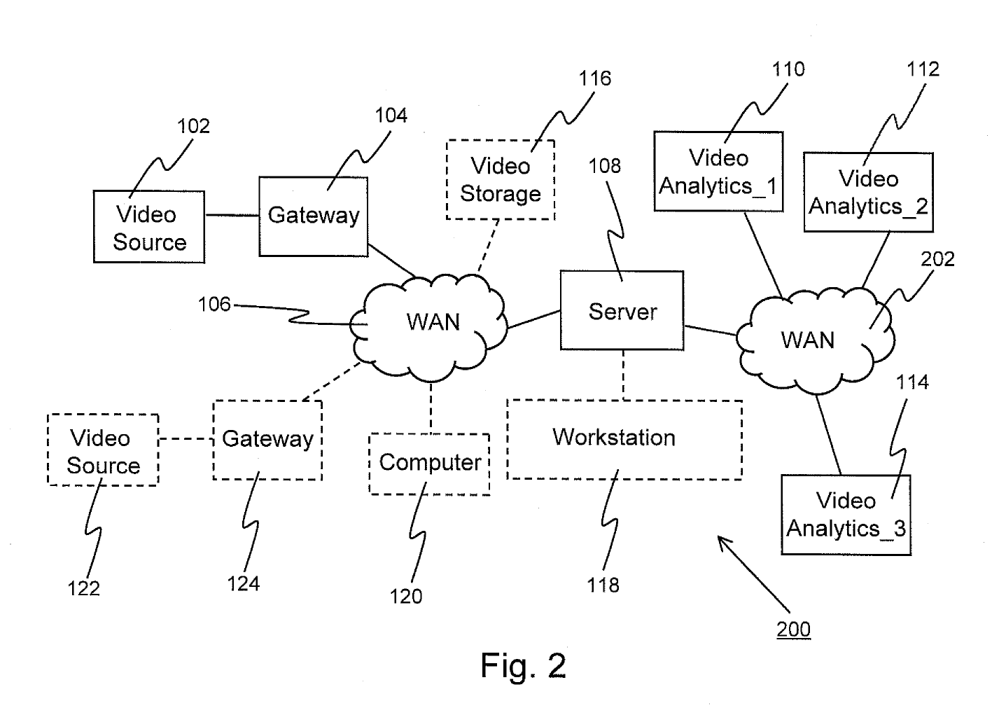

Referring now to FIG. 2, shown is a schematic block diagram of another system that is suitable for implementing a method according to an embodiment of the instant invention. The system 200 includes a video source 102 disposed at a source end. By way of a specific and non-limiting example, the video source 102 is a network IP camera, such as for instance an AXIS 211M Network Camera or another similar device. In the instant example the video source 102 is deployed at the source end for monitoring a known field of view (FOV). For example, the video source 102 monitors one of a parking lot, an entry/exit point of a building, and a stack of shipping containers. The video source 102 captures video data of the FOV at a known frame rate, typically 30 FPS, and performs on-board compression of the captured video data using a suitable compression standard such as for instance MPEG-4 or H.264. The compressed video data are provided to a central server 108 via gateway 104 and Wide Area Network (WAN) 106, such as for instance the Internet. Optionally, the video source 102 connects to the WAN 106 without the gateway 104. Optionally, the video source 102 is one of a still camera, another type of video camera, or a video data storage device.

The central server 108 receives transmitted video data from the video source 102 via a single IP stream over the WAN 106. Thereafter, the central server 108 provides the received video data to at least one of a plurality of available video analytics engines 110-114, which are indicated in FIG. 2 as Video Analytics_1 110, Video Analytics_2 112 and Video Analytics_3 114. By way of a specific and non-limiting example, during use each one of the different video analytics engines 110-114 is in execution on a different processor. For instance, during use each one of the different video analytics engines 110-114 is in execution on a processor of a different server at different locations that are remote from central server 108. In one embodiment, at least some of the video analytics engines are provided by a third party on one of a fee-per-use basis or on a subscription basis.

In the example that is illustrated in FIG. 2, the central server 108 provides the video data to at least one of the video analytics engines 110-114 over a Wide Area Network (WAN) 202. WAN 202 is either the same as WAN 106 or it is a different WAN. Optionally, WAN 202 has a bandwidth that is sufficient to support multiple video data streams from central server 108 to the video analytics engines 110-114, or central server 108 provides the video data to different ones of the video analytics engines 110-114 at different times in order to reduce the time-averaged bandwidth requirement on the WAN 202.

Referring still to FIG. 2, each of the different video analytics engines 110-114 performs a different video analytics function. By way of a specific and non-limiting example, Video Analytics_1 110 detects a vehicle within a data frame, Video Analytics_2 112 detects the vehicle license plate within a data frame, and Video Analytics_3 114 reads the license plate characters. By way of another specific and non-limiting example, Video Analytics_1 110 determines a number of people within a data frame, Video Analytics_2 112 detects loitering behavior within a data frame, and Video Analytics_3 114 performs facial recognition. As will be apparent to one of skill in the art, different applications require different video analytics engines and/or a different number of video analytics engines. Further, the video analytics engines need not perform related functions. A same frame is analyzable with respect to a presence of birds, the weather, and a presence of people each separately performed by different video analytics engines. Optionally, some or all of the video analytics engines 110-114 are fee-per-use-based or subscription based.

Further optionally, the system 200 includes a video storage device 116. By way of a specific and non-limiting example, the video storage device 116 is one of a digital video recorder (DVR), a network video recorder (NVR), or a storage device in box with a searchable file structure. The system 200 further optionally includes a workstation 118, including a not illustrated processor portion, display device and input device, which is in communication with server 108 for supporting end-user control and video review functions. Alternatively, the server 108 and the workstation 118 are combined, comprising for instance a personal computer including a display and input device. Optionally, a computer 120 is provided in communication with the WAN 106 for supporting remote access of the video data that is provided by the video source 102. For instance, a user uses a web browser application that is in execution on computer 120 for monitoring portions of the video data that are provided by the video source 102. Optionally, the computer 120 is a personal computer located at the source end or virtually anywhere else in the world. Alternatively, the computer 120 is a mobile electronic device, such as for instance one of a cell phone, a smart phone, a PDA, or a laptop computer.

Of course, optionally more than one video source is provided in communication with the central server 108. For instance, a second video source 122 is in communication with central server 108 via gateway 124 and Wide Area Network (WAN) 106. Optionally, the second video source 122 is the same type as video source 102. Alternatively the second video source 122 is a different type than video source 102. Further optionally, additional video sources are provided in communication with server 108. When different types of video sources are used, optionally the broker determines an engine suitable for the video data received. Further optionally, the broker modifies the video data in accordance with an input data requirement of the video analytics engine. Alternatively, the broker provides the video data to a separate processor for at least one of identification of a suitable analytics engine and reformatting of the data for the video analytics engine.

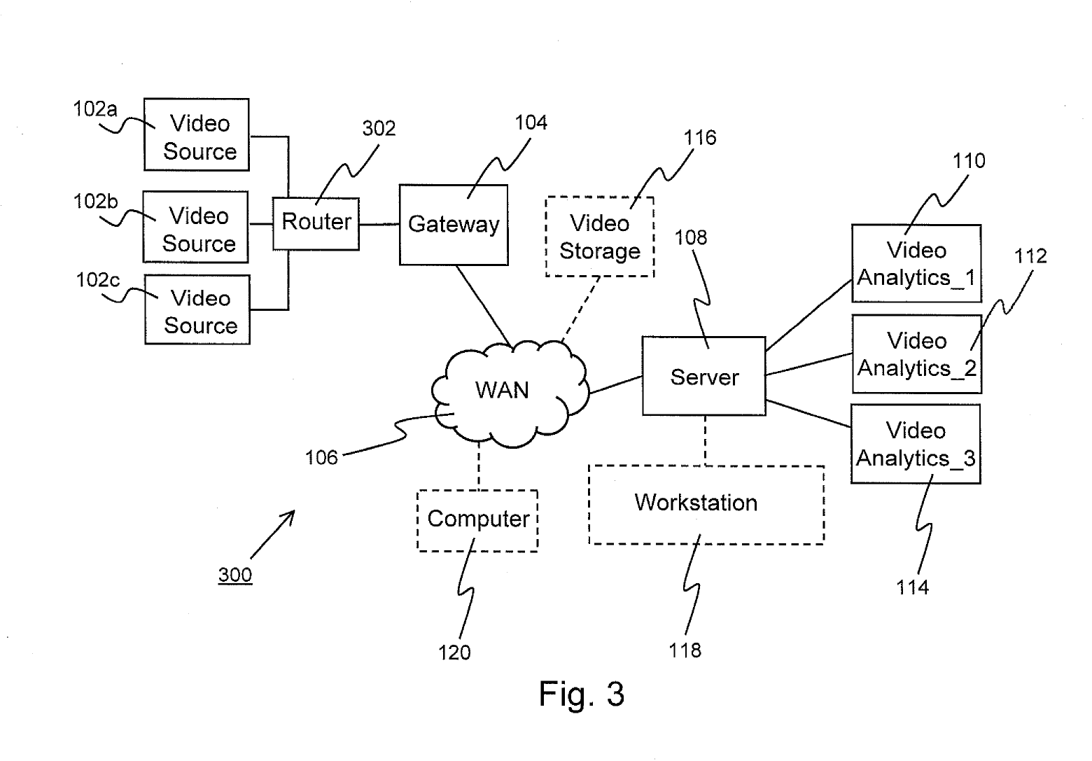

Referring now to FIG. 3, shown is a schematic block diagram of another system that is suitable for implementing a method according to an embodiment of the instant invention. The system 300 includes a plurality of video sources 102a-c associated with a same client and disposed at the acquisition end for monitoring a known field of view (FOV). For example, a first video source 102a monitors a parking lot, a second video source 102b monitors an entry/exit point of a building, and a third video source 102c monitors a stack of shipping containers. Each one of the video sources 102a-c captures video data at a known frame rate, typically 30 FPS, and performs on-board compression of the captured video data using a suitable compression standard such as for instance MPEG-4 or H.264. The compressed video data are provided to a central server 108 via gateway 104, router 302 and Wide Area Network (WAN) 106, such as for instance the Internet. Optionally, the video sources 102a-c connects to the WAN 106 without the gateway 104. Optionally, each one of the video sources 102a-c is one of a still camera, another type of video camera, or a video data storage device.

The central server 108 receives transmitted video data from the video sources 102a-c via a single IP stream over the WAN 106. Thereafter, the central server 108 provides the received video data to at least one of a plurality of available video analytics engines 110-114, which are indicated in FIG. 3 as Video Analytics_1 110, Video Analytics_2 112 and Video Analytics_3 114. In the example that is illustrated in FIG. 3, the central server 108 provides the video data over a Local Area Network (LAN), such as by opening a separate IP stream for each one of the video analytics engines 110-114 to which the video data is to be provided. By way of a specific and non-limiting example, during use each one of the different video analytics engines 110-114 is in execution on a different processor. For instance, during use each one of the different video analytics engines 110-114 is in execution on a processor of a different server of a server farm that is local to the central server 108. Alternatively, the central server 108 provides the video data over a Wide Area Network (WAN).

Referring still to FIG. 3, each of the different video analytics engines 110-114 performs a different video analytics function. By way of a specific and non-limiting example, Video Analytics_1 110 detects a vehicle within a data frame, Video Analytics_2 112 detects the vehicle license plate within a data frame, and Video Analytics_3 114 reads the license plate characters. By way of another specific and non-limiting example, Video Analytics_1 110 determines a number of people within a data frame, Video Analytics_2 112 detects loitering behavior within a data frame, and Video Analytics_3 114 performs facial recognition. As will be apparent to one of skill in the art, different applications require different video analytics engines and/or a different number of video analytics engines and different applications are simultaneously performable on same video data. Optionally, some or all of the video analytics engines 110-114 are fee-per-use-based or subscription based.

Further optionally, the system 300 includes a video storage device 116. By way of a specific and non-limiting example, the video storage device 116 is one of a digital video recorder (DVR), a network video recorder (NVR), or a storage device in box with a searchable file structure. The system 300 further optionally includes a workstation 118, including a not illustrated processor portion, display device and input device, which is in communication with server 108 for supporting end-user control and video review functions. Alternatively, the server 108 and the workstation 118 are combined, comprising for instance a personal computer including a display and input device. Optionally, a computer 120 is provided in communication with the WAN 106 for supporting remote access of the video data that is provided by the video source 102. For instance, a user uses a web browser application that is in execution on computer 120 for monitoring portions of the video data that are provided by the video source 102. Optionally, the computer 120 is a personal computer located at the source end or virtually anywhere else in the world. Alternatively, the computer 120 is a mobile electronic device, such as for instance one of a cell phone, a smart phone, a PDA, or a laptop computer.

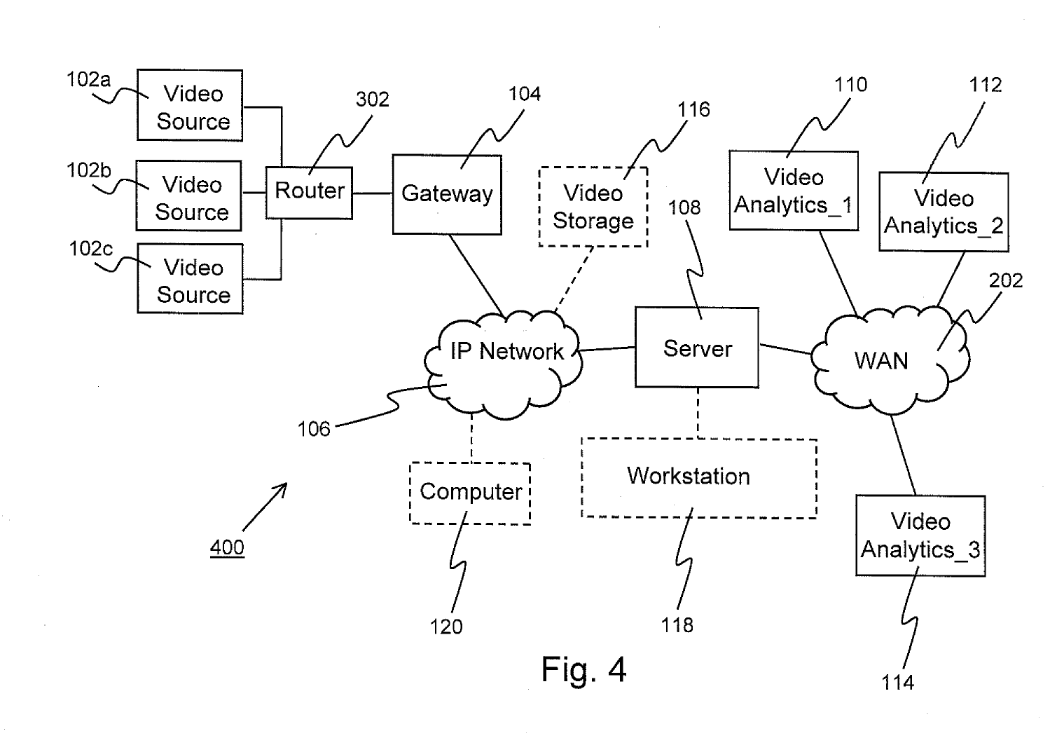

Referring now to FIG. 4, shown is a schematic block diagram of another system that is suitable for implementing a method according to an embodiment of the instant invention. The system 400 includes a plurality of video sources 102a-c associated with a same client and disposed at the acquisition end for monitoring a known field of view (FOV). For example, a first video source 102a monitors a parking lot, a second video source 102b monitors an entry/exit point of a building, and a third video source 102c monitors a stack of shipping containers. Each one of the video sources 102a-c captures video data at a known frame rate, typically 30 FPS, and performs on-board compression of the captured video data using a suitable compression standard such as for instance MPEG-4 or H.264. The compressed video data are provided to a central server 108 via gateway 104, router 302 and Wide Area Network (WAN) 106, such as for instance the Internet. Optionally, the video sources 102a-c connects to the WAN 106 without the gateway 104. Optionally, each one of the video sources 102a-c is one of a still camera, another type of video camera, or a video data storage device.

The central server 108 receives transmitted video data from the video sources 102a-c via a single IP stream over the WAN 106. Thereafter, the central server 108 provides the received video data to at least one of a plurality of available video analytics engines 110-114, which are indicated in FIG. 4 as Video Analytics_1 110, Video Analytics_2 112 and Video Analytics_3 114. By way of a specific and non-limiting example, during use each one of the different video analytics engines 110-114 is in execution on a different processor. For instance, during use each one of the different video analytics engines 110-114 is in execution on a processor of a different server at different locations that are remote from central server 108. In one embodiment, at least some of the video analytics engines are provided by a third party on one of a fee-per-use basis or on a subscription basis.

In the example that is illustrated in FIG. 4, the central server 108 provides the video data to at least one of the video analytics engines 110-114 over a Wide Area Network (WAN) 202. WAN 202 is either the same as WAN 106 or it is a different WAN. Optionally, WAN 202 has a bandwidth that is sufficient to support multiple video data streams from central server 108 to the video analytics engines 110-114, or central server 108 provides the video data to different ones of the video analytics engines 110-114 at different times in order to reduce the time-averaged bandwidth requirement on the WAN 202.

Referring still to FIG. 4, each of the different video analytics engines 110-114 performs a different video analytics function. By way of a specific and non-limiting example, Video Analytics_1 110 detects a vehicle within a data frame, Video Analytics_2 112 detects the vehicle license plate within a data frame, and Video Analytics_3 114 reads the license plate characters. By way of another specific and non-limiting example, Video Analytics_1 110 determines a number of people within a data frame, Video Analytics_2 112 detects loitering behavior within a data frame, and Video Analytics_3 114 performs facial recognition. As will be apparent to one of skill in the art, different applications require different video analytics engines and/or a different number of video analytics engines. Further, it is supported to perform multiple applications either in parallel or serially on same or similar video data. Optionally, some or all of the video analytics engines 110-114 are fee-per-use-based or subscription based.

Further optionally, the system 400 includes a video storage device 116. By way of a specific and non-limiting example, the video storage device 116 is one of a digital video recorder (DVR), a network video recorder (NVR), or a storage device in box with a searchable file structure. The system 400 further optionally includes a workstation 118, including a not illustrated processor portion, display device and input device, which is in communication with server 108 for supporting end-user control and video review functions. Alternatively, the server 108 and the workstation 118 are combined, comprising for instance a personal computer including a display and input device. Optionally, a computer 120 is provided in communication with the WAN 106 for supporting remote access of the video data that is provided by the video source 102. For instance, a user uses a web browser application that is in execution on computer 120 for monitoring portions of the video data that are provided by the video source 102. Optionally, the computer 120 is a personal computer located at the source end or virtually anywhere else in the world. Alternatively, the computer 120 is a mobile electronic device, such as for instance one of a cell phone, a smart phone, a PDA, or a laptop computer. Thought the video storage device is locatable anywhere within the WAN, optionally, it is local to the source of the video data. Further optionally, it is local to the server.

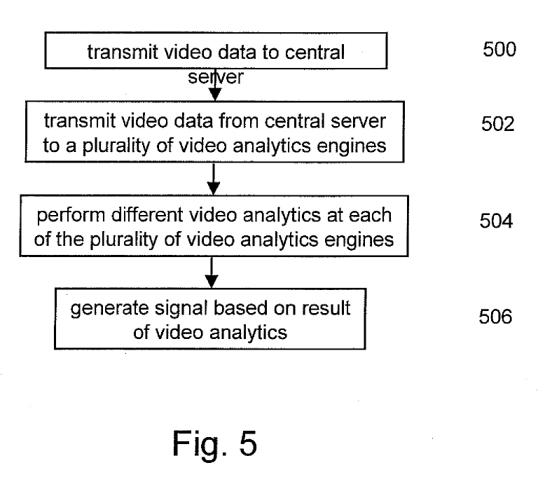

Referring now to FIG. 5, shown is a simplified flow diagram of a method according to an embodiment of the instant invention. The method that is described with reference to FIG. 5 may be carried out using at least one of the systems 100-400 described above. At block 500 video data is transmitted from the video source 102, or from at least one of the video sources 102a-c, disposed at the source end to the central server 108 via WAN 106. WAN 106 may be the Internet of the World Wide Web or any other communications network that uses such devices as telephone lines, satellite dishes, or radio waves to span a larger geographic area than can be covered by a LAN. In general, the transmitted video data includes video data relating to an event of interest captured using a video camera or other video sensor disposed at the source end. At 502 the central server 108 transmits the video data, via a plurality of IP streams, to each one of the plurality of different video analytics engines 110-114 that are available to the central server 108. Optionally, the plurality of IP streams is established across a LAN as described with reference to FIGS. 1 and 3, or across a WAN as described with reference to FIGS. 2 and 4. Alternatively, some IP streams of the plurality are established across a LAN and other IP streams of the plurality are established across a WAN. At 504 different video analytics processing of the video data is performed using each one of the plurality of different video analytics engines to which the video data was provided. At 506, based on at least a result that is provided by one of the plurality of different video analytics engines, a signal is generated for performing a predetermined action in response to an occurrence of the event of interest at the source end. Several non-limiting examples of a predetermined action include generating an alert, forwarding the video data for review by a human operator, storing at least a portion of the video data and providing at least a portion of the video data to another video analytics engine for further processing. In one embodiment, the alert is a human intelligible alert provided to an indicated user. Optionally, the alert is provided via a wireless communications channel to a portable electronic device associated with the indicated user. Further optionally, providing the alert comprises providing at least a portion of the video data relating to the event of interest, for being displayed to the indicated user. Additionally, the predetermined action may include billing or charging for video analytics usage. Optionally, more than one predetermined action results form the different video analytics processes.

Optionally, an alert is provided in dependence upon determining a correlation between a result provided by a first one of the plurality of different video analytics engines and a result provided by a second one of the plurality of different video analytics engines. When correlation between different video analytics engines is determined, the likelihood of a false alarm is reduced.

In an embodiment, the central server 108 transmits the video data to every available video analytics engine. In another embodiment, the central server 108 transmits the video data to one video analytics engine or to a plurality of different video analytics engines, where the plurality of different video analytics engines is a subset of a larger group of available video analytics engines. For instance, in the latter embodiment the video data is pre-processed at the source end and the central server 108 selects the subset of video analytics engines from the larger group of available video analytics engines based on a result of the pre-processing. By way of a specific and non-limiting example, if the pre-processing indicates that a person is present in the video data but a vehicle is not present in the video data, then central server 108 may transmit the video data to a video analytics engine that determines a number of people or that recognizes loitering behavior etc., but does not transmit the video data to a video analytics engine that identifies a vehicle license plate or that recognizes the characters on a vehicle license plate.

Alternatively, the central server 108 selects the plurality of different video analytics engines from the group of available video analytics engines based on a video analytics engine subscription-profile associated with the source end. For instance, if video analytics engines 110 and 114 are included in the subscription-profile and video analytics engine 112 is not included in the subscription-profile then the central server transmits data originating from the source end to video analytic engines 110 and 114 but not to video analytics engine 112. The subscription-profile is for instance part of a database that is accessible by the central server 108, which is stored either locally thereto or remote from the central server 108. Further alternatively, the central server 108 selects the plurality of different video analytics engines from the group of available video analytics engines based on a preference profile associated with the source end. By way of several specific and non-limiting examples, the preference profile may require that only free video analytics engines are to be used, that only face recognition video analytics engines are to be used, or may identify specific video analytics engines that are to be used. Optionally, preliminary video analytics processing is performed at the central server and the central server 108 selects the plurality of different video analytics engines from the group of available video analytics engines based on a result of the preliminary video analytics processing. Optionally, the central server 108 accesses a database based on a result of the preliminary video analytics processing to retrieve at least one of subscription-profile and preference-profile data. For instance, if the preliminary video analytics processing indicates that a vehicle may be present in the video data, then the central server 108 accesses a database to retrieve preference-profile data for video analytics engines relating to vehicles. Optionally, the preliminary video analytics processing is for determining whether a predetermined threshold criterion is present prior to providing the video data to a fee-based video analytics engine. For instance, in addition to simply detecting a vehicle the preliminary video analytics processing may also be required to determine that a threshold criterion is satisfied, such as the vehicle's speed exceeding a predetermined value and/or the vehicle's movement being along a predetermined path, prior to submitting the video data to a fee-based video analytics engine. In another optional implementation, central server 108 buffers or otherwise stores temporarily the video data received from the source end and sends the video data to one or more free or otherwise authorized video analytics engines, and if a predetermined result comes back send the same video data to another video analytics engine.

Referring still to FIG. 5, in another optional implementation the central server 108 selects the plurality of different video analytics engines from the group of available video analytics engines based on a knows configuration of the video source 102 or 102a-c. For instance, if it is known that the video source 102 or 102a-c is a video camera with on-board video analytics capability for detecting one of eight potential events, then the video source 102 or 102a-c provides video data including a known number of bits to indicate which of the potentials have been detected. Thus if all “0's” are included with the video data then the central server 108 does not send the video data to any of the video analytics engines. Similarly, if all “1's” are included with the video data then the central server 108 sends to the video data to all video analytics engines.

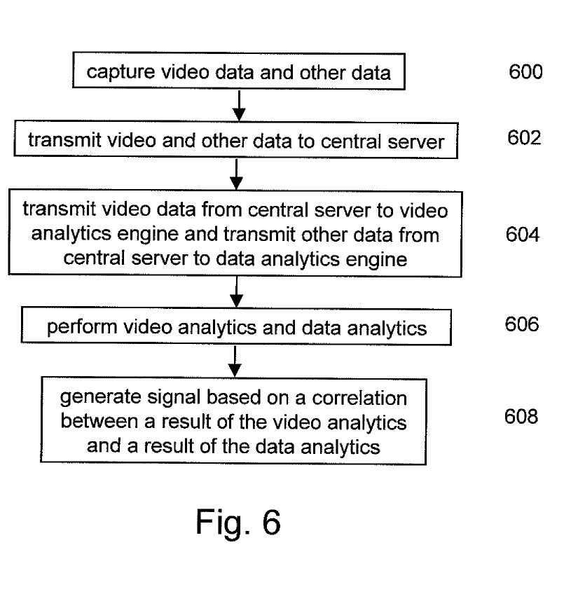

Referring now to FIG. 6, shown is a simplified flow diagram of a method according to an embodiment of the instant invention. The method that is described with reference to FIG. 6 may be carried out using at least one of the systems 100-400 described above. At block 600 video data is captured using a first type of sensor comprising a video camera disposed at a source end, and other data is captured using a second type of sensor disposed at the source end. In particular, the first type of sensor is different than the second type of sensor. Further, the video data and the other data each include data relating to an occurrence of a same event of interest at the source end. At 602 the video data and the other data are transmitted from the source end to a central server 108 via a Wide Area Network (WAN) 106. At 604 the video data is transmitted from the central server 108 to a video analytics engine via a first IP stream and the other data is transmitted to a data analytics engine via a second IP stream. In particular, the data analytics engine is selected from a plurality of available data analytics engines in dependence upon a type of the other data. At 606 video analytics processing of the video data is performed using the video analytics engine and data analytics processing of the other data is performed using the selected data analytics engine. At 608, based on determining a correlation between a result provided by the video analytics engine and a result provided by the selected data analytics engine, a signal is generated for performing a predetermined action in response to an occurrence of the event of interest at the source end. Several non-limiting examples of a predetermined action include generating an alert, forwarding the video data for review by a human operator, storing at least a portion of the video data and providing at least a portion of the video data to another video analytics engine for further processing. In one embodiment, the alert is a human intelligible alert provided to an indicated user. Optionally, the alert is provided via a wireless communications channel to a portable electronic device associated with the indicated user. Further optionally, providing the alert comprises providing at least a portion of the video data relating to the event of interest, for being displayed to the indicated user. Alternatively, the alert comprises a control signal for controlling a system or effecting an action by a remote user or system. Additionally, the predetermined action may include billing or charging for video analytics usage.

Optionally, the video data is provided to a plurality of different video analytics engines in a manner similar to that described with reference to FIG. 5. Further optionally, the other data is provided to a plurality of different data analytics engines also in a manner substantially similar to that described with reference to FIG. 5. Correlation of results of video analytics processing and other data analytics processing enable more selective responses to predetermined events.

By way of a specific and non-limiting example, which might be implemented in a university security scenario, the correlation of results based on video footage of a person being chased by another person and audio content of both persons laughing results in no alert being issued to the university security office. On the other hand, the correlation of results based on video footage of a person being chased by another person and audio content of the person that is being chased screaming for help does result in an alert being issued to the university security office.

By way of several specific and non-limiting examples, the second type of sensor is one or more of an audio sensor, a microphone, a heat sensor, a motion sensor, a passive infrared sensor, a pressure sensor, a smoke sensor, and another airborne particle sensor.

Referring still to FIG. 6, optionally the correlation between a result provided by the video analytics engine and a result provided by the selected data analytics engine is a correlation with respect to time. For instance, a correlation with respect to time exists when pleas for help are detected in audio content that is captured at the same time as video footage showing a person being chased. Alternatively, the correlation between a result provided by the video analytics engine and a result provided by the selected data analytics engine is a correlation with respect to space. For instance, a correlation with respect to space exists when a passive infrared sensor detects movement in a stairwell that is normally locked and a video camera subsequently captures footage showing a person running along a hallway that has access to the stairwell.

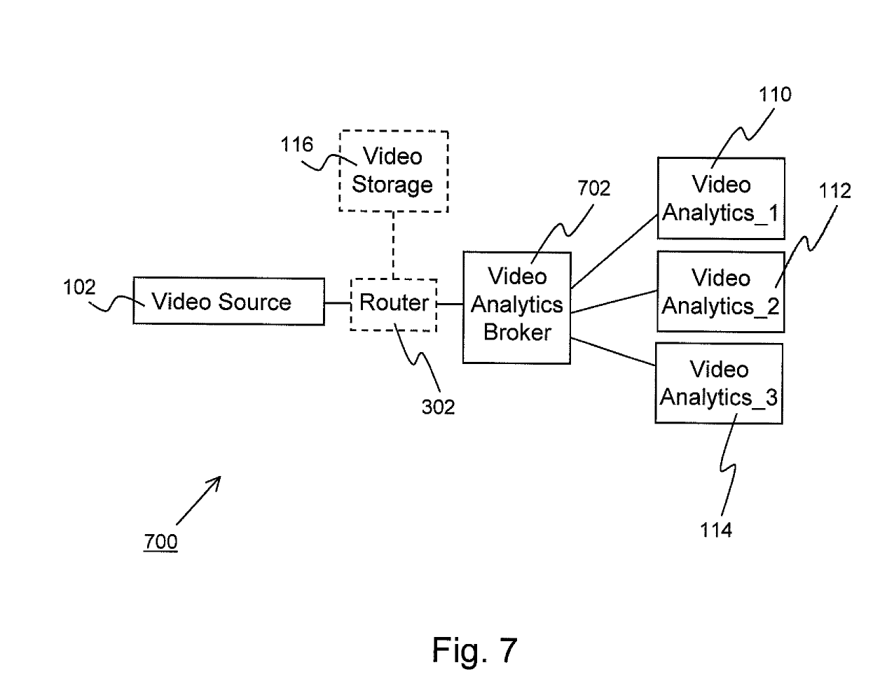

Referring now to FIG. 7, shown is a schematic block diagram of another system that is suitable for implementing a method according to an embodiment of the instant invention. The system 700 includes a video source 102, which is disposed at a source end. By way of a specific and non-limiting example, the video source 102 is a network IP camera, such as for instance an AXIS 211M Network Camera or another similar device. In the instant example the video source 102 is deployed at the source end for monitoring a known field of view (FOV). For example, the video source 102 monitors one of a parking lot, an entry/exit point of a building, and a stack of shipping containers. The video source 102 captures video data of the FOV at a known frame rate, typically 30 FPS, and performs on-board compression of the captured video data using a suitable compression standard such as for instance MPEG-4 or H.264. Optionally, the video source 102 is one of a still camera, another type of video camera, or a video data storage device.

The compressed video data are provided to a video analytics broker 702. By way of several specific and non-limiting examples, the video data is provided from the video source 102 to the video analytics broker 702 via one of a LAN, a WAN, a wireless communication channel and a direct connection such as a fiber optic cable or coaxial cable. Thereafter, the video analytics broker 702 provides the received video data to at least one of a plurality of available video analytics engines 110-114, which are indicated in FIG. 7 as Video Analytics_1 110, Video Analytics_2 112 and Video Analytics_3 114. In the example that is illustrated in FIG. 7, the video analytics broker 702 provides the video data over a Local Area Network (LAN), such as by opening a separate IP stream for each one of the video analytics engines 110-114 to which the video data is to be provided. By way of a specific and non-limiting example, during use each one of the different video analytics engines 110-114 is in execution on a different processor. For instance, during use each one of the different video analytics engines 110-114 is in execution on a processor of a different server of a server farm that is local to the video analytics broker 702. Alternatively, the video analytics broker 702 provides the video data to at least one of the video analytics engines 110-114 over a WAN (not illustrated). Optionally, the not illustrated WAN has a bandwidth that is sufficient to support multiple video data streams from video analytics broker 702 to the video analytics engines 110-114, or video analytics broker 702 provides the video data to different ones of the video analytics engines 110-114 at different times in order to reduce the time-averaged bandwidth requirement on the not illustrated WAN.

Referring still to FIG. 7, each of the different video analytics engines 110-114 performs a different video analytics function. By way of a specific and non-limiting example, Video Analytics_1 110 detects a vehicle within a data frame, Video Analytics_2 112 detects the vehicle license plate within a data frame, and Video Analytics_3 114 reads the license plate characters. By way of another specific and non-limiting example, Video Analytics_1 110 determines a number of people within a data frame, Video Analytics_2 112 detects loitering behavior within a data frame, and Video Analytics_3 114 performs facial recognition. As will be apparent to one of skill in the art, different applications require different video analytics engines and/or a different number of video analytics engines. Further, it is supported to provide the video data to video analytics engines for performing more than one application with the video data. Optionally, some or all of the video analytics engines 110-114 are fee-per-use-based or subscription based.

Further optionally, the system 700 includes a video storage device 116. By way of a specific and non-limiting example, the video storage device 116 is one of a digital video recorder (DVR), a network video recorder (NVR), or a storage device in box with a searchable file structure.

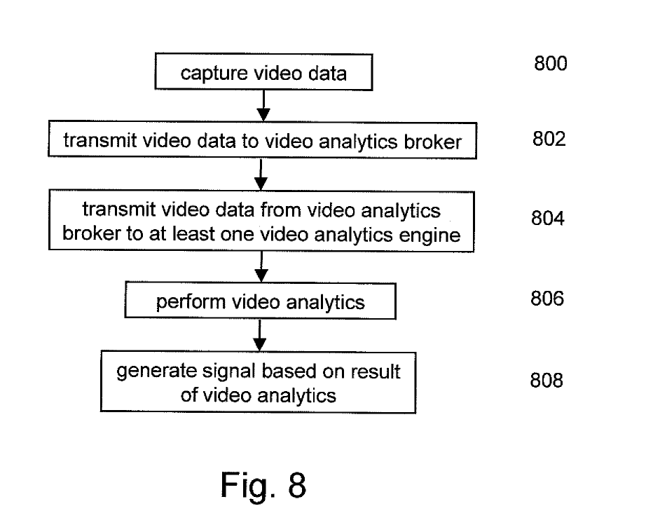

Referring now to FIG. 8, shown is a simplified flow diagram of a method according to an embodiment of the instant invention. The method that is described with reference to FIG. 8 may be carried out using, for example, at least the system 700 described above. At block 800 video data is captured using a video camera disposed at a source end, the video data including video data relating to an event of interest captured using the video camera. At 802 the video data is transmitted to a video analytics broker 702. In particular, the video data is transmitted to the video analytics broker via one of a WAN, a LAN, a wireless communication channel and a direct connection such as a fiber optic cable or coaxial cable. At 804 the video data is transmitted from the video analytics broker to at least one video analytics engine of a plurality of different video analytics engines that are accessible by the video analytics broker 702. At 806 video analytics is performed on the video data using the at least one video analytics engine. At 808, based on a result provided by the at least one video analytics engine, a signal is generated for performing a predetermined action in response to an occurrence of the event of interest at the source end. Several non-limiting examples of a predetermined action include generating an alert, forwarding the video data for review by a human operator, storing at least a portion of the video data and providing at least a portion of the video data to another video analytics engine for further processing. In one embodiment, the alert is a human intelligible alert provided to an indicated user. Optionally, the alert is provided via a wireless communications channel to a portable electronic device associated with the indicated user. Further optionally, providing the alert comprises providing at least a portion of the video data relating to the event of interest, for being displayed to the indicated user. Yet further optionally, the alert comprises a control signal for controlling or affecting a system in communication with the network. Additionally, the predetermined action may include billing or charging for video analytics usage.

Optionally, an alert is provided in dependence upon determining a correlation between a result provided by a first one of the plurality of different video analytics engines and a result provided by a second one of the plurality of different video analytics engines. When correlation between different video analytics engines is determined, the likelihood of a false alarm is reduced.

In an embodiment, the video analytics broker 702 transmits the video data to every available video analytics engine. In another embodiment, the video analytics broker 702 transmits the video data to one video analytics engine or to a plurality of different video analytics engines, where the plurality of different video analytics engines is a subset of a larger group of available video analytics engines. For instance, in the latter embodiment the video data is pre-processed at the source end and the video analytics broker 702 selects the subset of video analytics engines from the larger group of available video analytics engines based on a result of the pre-processing. By way of a specific and non-limiting example, if the pre-processing indicates that a person is present in the video data but a vehicle is not present in the video data, then video analytics broker 702 may transmit the video data to a video analytics engine that determines a number of people or that recognizes loitering behavior etc., but does not transmit the video data to a video analytics engine that identifies a vehicle license plate or that recognizes the characters on a vehicle license plate.

Alternatively, the video analytics broker 702 selects the plurality of different video analytics engines from the group of available video analytics engines based on a video analytics engine subscription-profile associated with the source end. For instance, if video analytics engines 110 and 114 are included in the subscription-profile and video analytics engine 112 is not included in the subscription-profile then the video analytics broker 702 transmits data originating from the source end to video analytic engines 110 and 114 but not to video analytics engine 112. The subscription-profile is for instance part of a database that is accessible by the video analytics broker 702, which is stored either locally thereto or remote from the video analytics broker 702. Further alternatively, the video analytics broker 702 selects the plurality of different video analytics engines from the group of available video analytics engines based on a preference profile associated with the source end. By way of several specific and non-limiting examples, the preference profile may require that only free video analytics engines are to be used, that only face recognition video analytics engines are to be used, or may identify specific video analytics engines that are to be used. Optionally, preliminary video analytics processing is performed at the central server and the video analytics broker 702 selects the plurality of different video analytics engines from the group of available video analytics engines based on a result of the preliminary video analytics processing. Optionally, the video analytics broker 702 accesses a database based on a result of the preliminary video analytics processing to retrieve at least one of subscription-profile and preference-profile data. For instance, if the preliminary video analytics processing indicates that a vehicle may be present in the video data, then the video analytics broker 702 accesses a database to retrieve preference-profile data for video analytics engines relating to vehicles. Optionally, the preliminary video analytics processing is for determining whether a predetermined threshold criterion is present prior to providing the video data to a fee-based video analytics engine. For instance, in addition to simply detecting a vehicle the preliminary video analytics processing may also be required to determine that a threshold criterion is satisfied, such as the vehicle's speed exceeding a predetermined value and/or the vehicle's movement being along a predetermined path, prior to submitting the video data to a fee-based video analytics engine. In another optional implementation, video analytics broker 702 buffers or otherwise stores temporarily the video data received from the source end and sends the video data to one or more free or otherwise authorized video analytics engines, and if a predetermined result comes back send the same video data to another video analytics engine.

Referring still to FIG. 8, in another optional implementation the video analytics broker 702 selects the plurality of different video analytics engines from the group of available video analytics engines based on a knows configuration of the video source 102 or 102a-c. For instance, if it is known that the video source 102 or 102a-c is a video camera with on-board video analytics capability for detecting one of eight potential events, then the video source 102 or 102a-c provides video data including a known number of bits to indicate which of the potentials have been detected. Thus if all “0's” are included with the video data then the video analytics broker 702 does not send the video data to any of the video analytics engines. Similarly, if all “l′s” are included with the video data then the video analytics broker 702 sends to the video data to all video analytics engines.

In an alternative embodiment, video data of a video source is used for alternative purposes depending on a situation. For example, a video camera pointing straight out of someone's front door is used to identify someone approaching the front door and optionally to record evidence of their arrival and departure. When noone is at the front door, the same source of video data records video data relating to the scene in front of the house. If, for example, in front of the house were a no parking zone, the video data, when noone is at the front door, is optionally routed to the parking division of the municipality for video analytics to determine a presence of a parked, ticketable vehicle in order to increase municipal revenue while enforcing parking bylaws. Thus, a camera installed for a user specified purpose, is useful by chance for another purpose as well. As will be evident, the two or more purposes could be provided simultaneously or hierarchically—one purpose supported first and foremost and a secondary purpose supported when the first purpose is unnecessary. Alternatively, a large number of different services are supported with one or more video data feeds. In a further alternative embodiment, different video data feeds are grouped together for different purposes such that a same video data source provides video data for use in several applications each relying on a different group of video data, a video data feed within at least two different groups, at least one of the two different groups comprising at least one video data feed that is other than within the other of the different groups.

Optionally, at least some of the video analytics engines are provided by a third party on one of a fee-per-use basis or on a subscription basis.

Numerous other embodiments may be envisaged without departing from the scope of the invention.

What is claimed is:

1. A method comprising:
transmitting video data from a source end to a central server via a Wide Area Network (WAN), the video data including video data relating to an event of interest captured using a video camera disposed at the source end;
via a plurality of streams, transmitting the video data from the central server to each one of a plurality of different video analytics engines; and,
performing different video analytics processing of the video data using each one of the plurality of different video analytics engines.

2. A method according to claim 1, comprising based on at least a result provided by one of the plurality of different video analytics engines, generating a signal for performing a predetermined action in response to an occurrence of the event of interest at the source end.

3. A method according to claim 2, wherein the signal is for providing an alert that is indicative of an occurrence of the event of interest at the source end.

4. A method according to claim 3, comprising providing the alert to an indicated user, wherein the alert comprises at least a portion of the video data relating to the event of interest for being displayed to the indicated user.

5. A method according to claim 4, wherein the alert is a human intelligible alert for being provided to the indicated user.

6. A method according to claim 4, wherein the alert is provided via a wireless communications channel to a portable electronic device associated with the indicated user.

7. A method according to claim 3, wherein the alert is provided in dependence upon determining a correlation between a result provided by a first one of the plurality of different video analytics engines and a result provided by a second one of the plurality of different video analytics engines.

8. A method according to claim 2, wherein the signal is for forwarding the video data for review by a human operator.

9. A method according to claim 2, wherein the signal is for storing at least a portion of the video data in a non-volatile memory storage device.

10. A method according to claim 2, wherein the signal is for providing at least a portion of the video data to another video analytics engine for further video analytics processing.

11. A method comprising:
capturing video data using a first type of sensor comprising a video camera disposed at a source end and capturing other data using a second type of sensor disposed at the source end, the first type of sensor different than the second type of sensor, the video data and the other data each including data relating to an occurrence of a same event of interest at the source end;
transmitting the video data and the other data from the source end to a central server via a Wide Area Network (WAN);
transmitting the video data from the central server to a video analytics engine via a first IP stream and transmitting the other data to a data analytics engine via a second IP stream, the data analytics engine selected from a plurality of available data analytics engines in dependence upon a type of the other data; and,
performing video analytics processing of the video data using the video analytics engine and performing data analytics processing of the other data using the selected data analytics engine.

12. A method according to claim 11, comprising, based on determining a correlation between a result provided by the video analytics engine and a result provided by the selected data analytics engine, generating a signal for performing a predetermined action in response to an occurrence of the event of interest at the source end.

13. A method according to claim 12, wherein the signal is for providing an alert that is indicative of an occurrence of the event of interest at the source end.

14. A method according to claim 13, comprising providing the alert to an indicated user, wherein the alert comprises at least a portion of the video data relating to the event of interest for being displayed to the indicated user.

15. A method according to claim 14, wherein the alert is a human intelligible alert for being provided to the indicated user.

16. A method comprising:
capturing video data using a video camera disposed at a source end, the video data including video data relating to an event of interest captured using the video camera;
transmitting the video data to a video analytics broker;
transmitting the video data from the video analytics broker to at least one video analytics engine of a plurality of different video analytics engines that are accessible by the video analytics broker; and,
performing video analytics on the video data using the at least one video analytics engine.

17. A method according to claim 16, comprising, based on a result provided by the at least one video analytics engine, generating a signal for performing a predetermined action in response to an occurrence of the event of interest at the source end.

18. A method according to claim 17, wherein the signal is for providing an alert that is indicative of an occurrence of the event of interest at the source end.

19. A method according to claim 18, comprising providing the alert to an indicated user, wherein the alert comprises at least a portion of the video data relating to the event of interest for being displayed to the indicated user.

20. A method according to claim 19, wherein the alert is a human intelligible alert for being provided to the indicated user.
